(19) United States
(12) Patent Application Publication
(10) Pub. No.: US 2006/0155561 A1
(43) Pub. Date: Jul. 13, 2006

(54) Mass customization of liquid packets

(76) Inventor: William Anthony Harper, Redmond, WA (US)

Correspondence Address: William Harper, 16541 Redmond Way, PMB 140, Redmond, WA, 98052-4492, US

(21) Appl. No.: 11/033,903

(22) Filed: Jan. 12, 2005

(51) Int. Cl. G06Q 99/00

(52) U.S. Cl. 705/1

(57) ABSTRACT

A method is provided comprising the online design of an insert by a user and the subsequent packaging of the custom insert with liquids. The insert is designed, approved, and ordered by the user through an internet interface that in turn supplies the insert design to an extremely scalable assemblage process within a high volume manufacturing operation which produces a custom finished product quickly, on demand, at low cost, and in quantities determined by the user. By incorporating the custom insert as a changeable modular component within an assembly line a mass produced product, specifically a packet package of hand sanitizer fluid, can be individually characterized by its insert as fully intended by the user who designed, ordered, and receives the packaged liquid packet insert.

### FIELD OF THE INVENTION

The present invention relates to liquid packet insert design and fabrication by internet means. In particular, the invention employs access to an automated system where the designer/user utilizes online design and mass customization techniques capable of producing small-scale runs of an item like a liquid packet insert which imparts its specific character to an otherwise mass produced package with which it is incorporated so as to enhance distribution and employment of both products per the intents of the insert designer/user.

### BACKGROUND OF THE INVENTION

Good hand hygiene is a major defense against infectious diseases and instant hand sanitizer fluids are widely endorsed by both health and medical authorities as a tool providing the first line of defense against sickness and disease. But in order to provide effective protection against ever-present pathogens it is necessary to have these fluids conveniently available for use in a timely fashion. Solutions to these concerns have been set forth in pending U.S. patent application Nos. 10/602,448 and 10/697,067 both to Harper. In '067 Harper disclosed a method using inserts within packets of hand sanitizing fluids to enhance distribution and retention of the packets to encourage this timely use. These inserts, Tagins™, are designed to advertise, inform, and entertain while playing a key role in preventing infectious disease.

In order for the Tagins to be effective they need to be highly aligned with the interests and intents of the user who will employee or distribute them. That user could be a restaurant owner who distributes Athand™ packets to patrons that contain Tagins advertising the establishment and its hours; a hospital passing out Athand packets to visitors and patients that bear important health tips; or a PTA providing word riddles on its Tagins to build the spelling and vocabulary skills of their kids while teaching a lifelong health habit. The range of inventive possibilities as to content and creative designs is as diverse as the number of users, some means of linkage between the user and the manufacturing process needs to be established to accommodate this endless expression of originality. But the manufacture of small disposable packets costing only a few cents necessitates mass production techniques where economies of scale demand highly standardized products that preclude both variety and customization by the very nature of the manufacturing process. There is no affordable option in such operations for short custom runs of a few hundred packets advertising an upscale falafel cart owner's offerings that can be provided to customers so they have clean hands with which to eat their treats. That the buyer will see the cart advertised several times throughout the day with each use of the Athand packet is a bonus for the cart owner. There is an unmet need in the marketplace where affordable liquid packet inserts and their packaging can be directly designed, approved, ordered, and subsequently manufactured under the control of the user and based solely on their unique intents for the product.

### SUMMARY OF THE INVENTION

The present invention discloses a method to overcome the existing limitations in and advances the art of mass customization of products. Specifically disclosed is a method that facilitates online design and ordering of customized inserts packaged with liquids within packet packages. This user-based product customization promotes the acquisition, retention and subsequent use of the liquid product because the customization step highly aligns the product with the intended use envisioned by the product designer and purchaser. In the preferred embodiment this is illustrated by the creation of engaging inserts packaged with a hand sanitizing fluid with the intent that these inserts will promote the acquisition, retention and convenient availability of the fluid packet so the likelihood of a timely action of hand rubbing will occur and reduce sickness and disease. That the insert was created to advertise, inform, and/or entertain as planned by the designer/user becomes a subsumed intent to the larger synergistic purpose achieved when the insert is associated with the packaged hand sanitizing fluid product, in this illustration, that purpose being improved health. Fundamental to achieving such an overarching purpose is the high alignment of the user's intents by facilitating the custom design of inserts so they completely satisfy the requirements envisioned by the user/purchaser, and to do so at an affordable price.

The method of the present invention provides the user with online access through a computer network interface to a process that begins with selection of a suitable insert template from a collection available from a template library. A modification process then is undertaken wherein the user may chose in varying degrees to interactively incorporate a variety of elements that include color, design, text and graphic selections and material choices. Following any modifications of the selected template a resulting optimized image is proofed and accepted by the user as being satisfactory for all intents and purposes. Using the approved image of the insert, a fabrication order is issued by the user. This order contains information necessary to the subsequent manufacturing process and interactively supplied authorization information necessary for obtaining all approvals for completing and generating the order.

Manufacturing is a process where the insert is fabricated per the order, in the designs specified, with the content created, and on the substratum called for. Further manufacturing associates the insert with selected packet and liquid materials as specified in a high volume, automated assembly line. The completed package formed as a packet of liquid containing an insert is shipped to the user per instructions derived from the order data. The insert contained in the packet package is used or distributed to advertise, inform, and entertain per the user's intentions.

A primary objective of the present invention is to provide a method allowing the essentially unlimited range of user interests to find a means of expression so the final custom product is highly aligned to those interests and increase the likelihood the associated product will be acquired and retained for eventual use.

Another objective of the present invention is a method to encourage through the attractiveness of the insert the distribution, retention, and use of hand sanitizing fluids to reduce sickness and disease.

Another objective of the present invention is a method to produce product at low cost through immediate user participation in a process involving online design, approval, and ordering that flows directly into highly automated operations designed to encapsulate numerous small runs as a long run.

Another objective of the present invention is a method that is utterly scalable so the unit cost for small orders of tens is the same as for larger orders of thousands.

Another object of the present invention is a method that is highly adaptable to continual content change of product without incurring significant additional costs.

Another object of the present invention is a method that encourages participation by providing categories of predetermined templates from a library that includes sets of inserts representing such topics as 150 word definitions, 50 political jokes, 100 chemical formulas, and other collections accessed by topic.

Another object of the present invention is a method that creates a product for a new cost effective form of popular advertising.

Another object of the present invention is a method that associates mass customization techniques with just-in-time manufacturing principles to eliminate material waste in production of a consumer product.

A final object of the present invention is a method that reduces finished product storage costs, product lifespan issues, and capital lockup by employing a demand-production system wherein product manufacturing is initiated only at the time of product sale.

Other objects and advantages of the present invention will become apparent from the following detailed description taken in conjunction with the accompanying drawing wherein are set forth, by way of functional and temporal relationships, certain embodiments of this invention. The drawing constitutes a part of this specification.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a flow chart representing the generalized systems components of liquid packet insert design, fabrication and packet manufacture.

### DETAILED DESCRIPTION OF THE INVENTION

While the invention will be described in connection with illustrations, descriptions, and examples of preferred embodiments, it will be understood these are not intended to limit the present invention only to these embodiments. On the contrary, the present invention is to cover all practices and/or functional alternatives are defined by the appended claims.

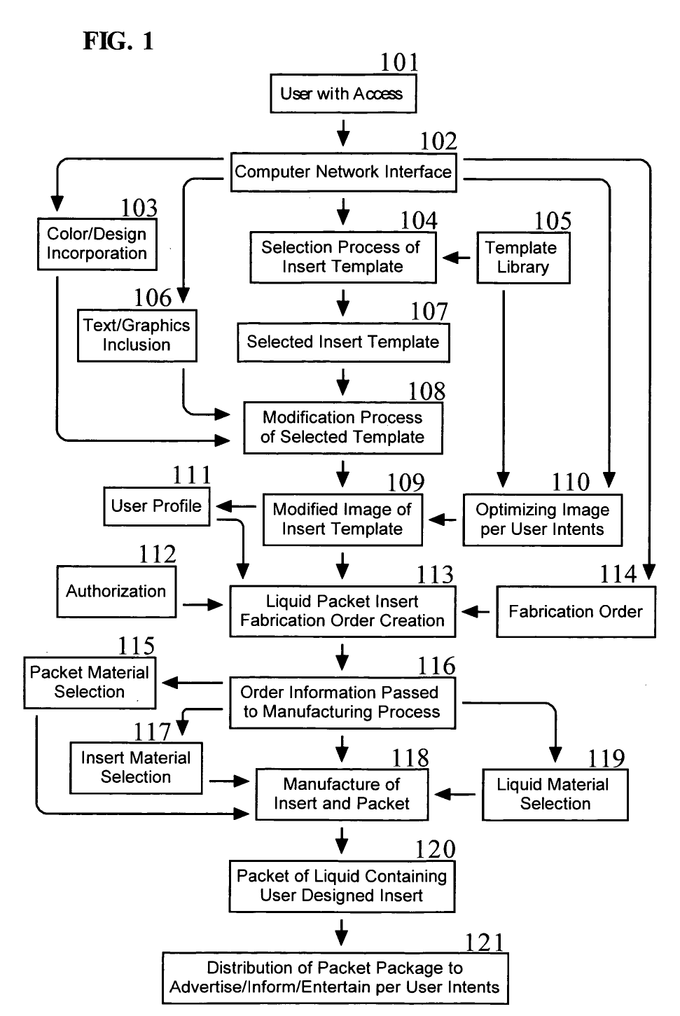

The overall general structure of the method of the present invention is illustrated in FIG. 1. A user with access 101 comprises a circumstance where a user with a need for a liquid packet insert has a means to access a system capable of producing such a product. Such access is provided through an interactive computer network interface 102 typically described as an online internet connection to the World Wide Web. The tool that provides the user access and means to visualize images is a personal computer with monitor, handheld portable personal computer, laptop, or mainframe computer workstation, all with internet communication or similar data communication interface capability.

Through the computer network interface 102 interactive communication is established with the system through common log in techniques found on websites throughout the internet. Once access to the system has been established the user enters the selection process wherein choices of sample inserts are provided for use as modeling templates 104. Depending upon the experience level of the user a tutorial program may be the first activity required of a new or novice user whereby they learn how to navigate the site, employee its tools, and otherwise successfully use the site to develop product. For experienced or otherwise knowledgeable users they may proceed directly into the workshop process to first select their template from among the samples arrayed and then build and/or model upon that base by inclusion and modification. The workshop analogy is a useful technique to envision the process undertaken in designing the content of the insert's image, the substratum that image will be placed on, the insert's eventual fabrication, and subsequent inclusion in a manufacturing operation. A variety of well-known graphic techniques, tools, and palettes are used to build the insert image in this virtual workshop; representative of such commonly available and popular software programs with these capabilities is Microsoft's Publisher. And just like in any workshop the user/craftsman's skill will be reflected in their experience and how these tools are wielded. For example, faced with how to start a user should first tour the template library 105 looking at the examples of existing sample insert models, acquainting themselves with the range of possibilities, and seek one that would make a good template to start with. This template insert should align with the user's intention for their insert. To assist the user the library can be viewed with the aid of an index where type and/or style may be specified to subset select samples for viewing. The vast array of examples showing samples with colors, designs, text and graphics shows what is possible with this evolving art form that has its genesis in the matchbook art of the last century. Further, the substrata materials and arrangements of such are also found in the library 105 to educate the user on the advanced features of the art. Also included in the library 105 are collections of inserts that contain many inserts, each with a differing meaningful communication; these are offered as sets. For example, an inspirational religious message for each day may comprise a set of 120 inserts; a colored photographic image of different North American shorebirds on 75 inserts; or a set of 50 inserts where each bears a different flag, motto, capital, and name for each state of the United States. The library 105 contains a great number of individual and set inserts from which to choose a template. The selection process 104 also permits an experienced user to simply select a basic blank template option and overlay it with a complete design imported from the user's own personal computer where it had already been built with a compatible computer-readable format such as one of Publisher's exchange format options. Eventually, from the library, a specific insert template is selected 107 and established as the modeling template format for further processing.

The modification process of the selected template 108 involves use of various interactive tools and techniques common to graphic software to manipulate and/or select and/or input of color, design 103, text, and graphics 106 elements of and for the template. By this modification process 108 the designer/user creates a custom product bearing meaningful communications that are highly aligned with the intents and purposes envisioned. By full and sole participation the designer/user has taken complete control of the product design process. This interactive process continues until the designer/user is satisfied with the view of the modified image 109.

Optimizing the image 110 involves selection of an appropriate substratum from the library 105 for the modified image 109 just developed. Substratum is the material base, typically a polymeric film, upon which the image will be placed. Substratum parameters such as coatings, colors, compositions, foldings, reflectivities, shapes, sizes, stiffness, textures, transparencies, volumes, and weights can all affect the applied image. Further, in some envisioned configurations, multiple pieces of substratum may constitute a single insert. Selecting and viewing the virtual image resulting from the interplay of the two elements, substratum and image, may well require either returning to the modification process 108 to redesign or selection of another substratum from the library 105 until an optimized image 110 is satisfactorily achieved. At this juncture the user may choose to place the optimized image in the library 105 so the thus saved insert can be used in the future as a template in the gateway selection process 104; this will save time in the future when relatively slight modification is needed and a total rebuild can be avoided. Also created is user profile 111 in which user-supplied design information is registered. Upon development of a satisfactory optimized image the user specifically acknowledges the image proof as acceptable and passes the now optimized modified image of the insert template 109 to the order creation process 113.

The liquid packet insert data file resulting from the designer phase contains the template image and substratum parameters as developed, proofed, and approved by the user. Next the fabrication order 113 is created when the user provides the fabrication order 114 information and authorizes payment. Order information together with insert data is used to establish or update a user profile 111 of this and previous order details. This profile also provides a manufacturing tracking code and subsequent shipping information for the ordered and manufactured insert product. Also included in the profile are alternative personnel allowed to utilize established proprietary assets and permissions. Authorization 112 for payment, typically by credit card, is performed by routines common to many website where such payments are transacted. Confirmation of such authorization may be made by email notification, internet communication, mail, telephone, or facsimile. Upon completion of these various steps the order package comprising the optimized image data, substratum parameters, manufacturing batch number, and order information is passed to the manufacturing process 116.

Process preparation 116 for the actual manufacturing of insert and packet 118 involves primarily the gathering of select material and scheduling. The most variable component in the operation is the liquid packet insert. Fabrications of the insert consists of selecting sufficient insert material 117 per the substratum parameters and printing or otherwise creating the optimal image on its surface and creation of the number or set required. This operation is typically done by laser printers with the resulting sheets cut to create individual inserts of the specified size and shapes. These individual inserts are batched with other batches of inserts that will be incorporated with the same type of packet 115 and useful liquid 119 so as to permit high speed assembly. This batching of small runs to constitute long runs gains the efficiency of mass production while preserving the mass customization characteristics of short runs. Scheduling the long run batch brings together a tray of batched inserts 117, packet forming material 115, and selected liquid material 119 for manufacturing 118.

In the preferred embodiment of this method the liquid is an alcohol based hand sanitizing fluid contained by a packet made of a high barrier polymeric laminate material formed to enclose a three-color advertisement image on a transparent polymeric substratum designed for a fine restaurant where it is placed with the dinner napkin for use by a patron. Produced by the manufacturing process 118 is at least one package of a packet of liquid containing a user designed insert 120. The short batch of at least one packet is separated from the others in the long batch by the short batch's tracking code previous created during the fabrication order creation 113 step. This code also links shipping information to the short batch. The package of packets containing the custom liquid inserts is shipped to the user for distribution or use per the user intents 121.

It is to be understood that even though numerous characteristics and advantages of the present invention have been set forth in the foregoing description, together with details of the structure, function, and employment of the invention, the disclosures are illustrative only, and changes may be made in details, especially in matters of tools employed and step arrangements, within the principles of the invention to the full extent indicated by the broad general meaning of the terms in which the appended claims are expressed.

Further, within this specification various applications have been referenced. The disclosures of these references in their entireties are hereby incorporated by reference in order to more fully describe the state of the art to which the invention pertains. Specifically called out for inclusion are definitions of terms found therein and employed herein. Additionally, novel methods for the design and manufacture of liquid packet inserts and their use in liquid packets have been described and illustrated by way of functional examples. While these descriptions have been illustrated and described with reference to certain preferred embodiments, the present invention is not limited thereto. In particular, the foregoing specification and embodiments are intended to be illustrative and are not to be taken as limiting. Thus, alternatives, such as structural or mechanical, software and/or functional equivalents, and other modifications will become apparent to those skilled in the art upon reading the foregoing description. Accordingly, such alternatives, changes, and modifications are to be considered as forming a part of the present invention insofar as they fall within the spirit and scope of the appended claims.

What is claimed is:

1. A method of providing customized liquid packets inserts to a user, said method comprising the steps of:
providing a choice of sample inserts for selection by said user as a modeling template;
selecting one or more of said sample inserts as a template insert;
inputting by said user one or more texts and/or graphics as meaningful communications;
superposing said texts and/or graphics onto portions of said template insert;
selecting one or more colors and/or designs from a pallet of colors and/or designs;
modifying template insert and/or superpositioned selected text and/or graphics with selected colors and/or designs to generate an image of a liquid packet insert; and
adjusting said text and/or graphics and/or colors and/or designs to generate an optimized image of a customized liquid packet insert in accordance with the intentions of said user.

2. The method of claim 1 further comprising the step of generating insert manufacturing parameters and procedures in accordance with said optimized image and said user inputs and selections.

3. A method of providing customized liquid packets inserts to a user linked to a computer network interface, said method comprising configuring the customized liquid packet insert for the user linked to a computer network interface, wherein the configuring includes the steps of:
providing a plurality of sample insert templates for selection by said user via said computer network interface;
receiving a request from said user indicating selection of at least one of said insert templates;
receiving texts and/or graphics as meaningful communications from said user for inclusion with said selected templates;
providing said user with a plurality of available colors and/or designs for incorporation into portions of said selected template;
receiving a request from said user indicating selection of at least one of said colors and/or designs;
providing said user with an image of said selected insert template incorporating at least one said selected colors and/or designs and/or texts and/or graphics as meaningful communications;
adjusting said image and said template into a modified image and a modified template to optimize the effectiveness of a liquid packet insert in accordance with the intents of said user;
receiving a request from said user to order at least one liquid packet insert made in accordance with said modified image incorporating said modified template; and
forwarding information related to said modified image for fabrication into at least one liquid packet insert made in accordance with said modified image and said modified template.

4. The method of claim 3 wherein the configuring further comprises the steps of:
receiving information from said user relating to liquid packet insert type and/or style; and
initially selecting said insert templates in accordance with said user-provided information prior to being provided to said user for selection.

5. The method of claim 3 wherein said selected insert templates is a pre-existing set of inserts each bearing individual meaningful communications.

6. The method of claim 4 further comprising the steps of:
forwarding said request to a manufacturing system; and
manufacturing a liquid packet insert in accordance with said user selections and inputs.

7. A method of claim 6 further comprising the steps of:
assembling said manufactured liquid packet insert with appropriate packet material and liquid to form a single package unit;
manufacturing at least one packet package containing said liquid and said liquid packet insert therein and fulfilling said user order to manufacture.

8. The method of claim 7 wherein said liquid is a hand sanitizing fluid.

9. The method of claim 8 wherein said hand sanitizing fluid is used to reduce hand-borne pathogens.

10. The method of claim 7 wherein said fluid is a useful fluid.

11. A method of providing a liquid packet insert to a user linked to a computer network interface, said method comprising configuring the liquid packet insert for the user linked to a computer network interface and sending an ordering request to order a liquid packet insert, wherein the configuring includes the steps of:
displaying a template insert image to assist said user in visualizing selected options for a liquid packet insert;
displaying inputted texts and/or graphics by said user to said user, said texts and/or graphics selectable for inclusion in said image;
displaying a plurality of liquid packet insert selection options to said user, said selection options including a plurality of selectable insert colors and/or insert design patterns; and
adjusting said image into a modified template image to optimize the incorporation of selected information from said user into said image.

12. The method of claim 11 further comprising the steps of:
incorporating insert colors and/or insert designs and/or insert texts and/or insert graphics selected by the user into said order request;
receiving the ordering request;
manufacturing a liquid packet insert incorporating said insert colors and/or insert designs and/or insert texts and/or insert graphics selected by said user; and
combining said liquid packet unit with an appropriate packet material and liquid means to manufacture a packet package so as to complete said order request.

13. The method of claim 11 wherein the configuring further comprises the step of deriving a liquid packet insert pattern that, when distributed, advertises and/or informs and/or entertains according to the intentions of the user.

14. The method of claim 12 wherein the configuring further comprises the step of deriving a liquid packet insert image that, when distributed, advertises and/or informs and/or entertains according to the intentions of the user.

15. The method of claim 11 wherein the configuring further comprises the step of incorporating all or some portion of a user-supplied graphic to create an image for use as said template insert image.

16. The method of claim 11 wherein the configuring further comprises the steps of:
incorporating said insert colors and/or insert design patterns and/or insert texts and/or insert graphics selected by said user into said template insert image to produce a modified template insert image; and
display said modified template image to said user for approval.

17. The method of claim 11 wherein said user is linked to a computer network via a user interface, and at least said steps of displaying liquid packet insert selection information and sending said ordering request are performed via said interface.

18. The method of claim 17 wherein said user interface is a personal computer having a display.

19. The method of claim 18 wherein said user interface is a handheld portable personal computing device.

20. The method of claim 18 wherein said user interface is a laptop computer.

21. The method of claim 17 wherein said user interface is a workstation associated with a mainframe computer.

22. The method of claim 11 wherein said modified template image is substantially accurate representation of the produced liquid packet insert.

23. The method of claim 22 further comprising the step of manufacturing a liquid packet insert substantially resembling said modified template image.

24. The method of claim 11 further comprising the step of forwarding said order request to a manufacturing facility for producing said insert in accordance with the insert colors and/or insert designs patterns and/or insert texts and/or insert graphics selected by the user.

25. The method of claim 11 further comprising the step of providing an image of a liquid packet insert to said user incorporating selected insert colors and/or insert design patterns and/or insert texts and/or insert graphics for review by said user.

26. The method of claim 11 wherein said liquid packet insert design patterns selectable options further comprise insert substratum parameters.

27. The method of claim 26 wherein said substratum parameters are selected from a group consisting of coatings, colors, compositions, foldings, reflectivities, shapes, sizes, stiffness, textures, transparencies, volumes, weights, and combinations thereof.

28. The method of claim 26 wherein said liquid packet insert design pattern selection options further comprises multiple inserts in one liquid packet package as a parameter.

29. A method of providing a liquid packet insert to a user linked to a computer network interface, said method comprising configuring the liquid packet insert for the user linked to a computer network interface and sending an ordering request to order a liquid packet insert, wherein the configuring comprises the steps of:
displaying a template insert image to assist said user in visualizing selected options for a liquid packet insert;
displaying a plurality of liquid packet insert selection options to said user, said selection options including a plurality of selectable insert colors and/or insert design patterns; and
requesting submission of textual and/or graphic images from said user for incorporation into said liquid packet insert and displaying a modified template image to said user incorporating submitted textual and/or graphic images.

30. The method of claim 29 wherein said textual and/or graphic images are requested through said user interface, said graphic design images further comprising image files in computer-readable format.

31. A method of providing a liquid packet insert to a user linked to a computer network interface, said method comprising configuring the liquid packet insert for the user linked to a computer network interface and sending an ordering request to order a liquid packet insert, wherein the configuring comprises the steps of:
displaying a template insert image to assist said user in visualizing selected options for a liquid packet insert;
displaying a plurality of liquid packet insert selection options to said user, said selection options including a plurality of selectable insert colors and/or insert designs patterns; and
obtaining user-supplied information from said user, such as texts and/or graphics as meaningful communications, for customizing insert and/or incorporating said user-supplied information into said ordering request.

32. The method of claim 31 further comprising the step of confirming said user-supplied information with an authorizing source.

33. The method of claim 32 wherein said step of confirming further comprises at least one method selected from a group comprising email notification, internet communication, mail, telephone, and facsimile.

34. The method of claim 33 wherein said customized liquid packet insert is configured for use by a person other than said user.

35. A method of providing a customized liquid packet insert to a user linked to a computer network interface, said method comprising configuring the customized liquid packet insert for the user linked to a computer network interface, sending an ordering request to order a liquid packet insert, and wherein the configuring includes the steps of: displaying a template insert image to assist said user in visualizing selected options for a customized liquid packet insert displaying a plurality of liquid packet insert selection options to said user; said selection options including a plurality of selectable insert colors and/or insert design patterns; accepting text and/or graphics as user-supplied information into template image; adjusting said image into a modified template image to optimize the incorporation of selected information from said user into said image, and creating a user profile for said user, said profile incorporating at least the user-supplied order information for said customized liquid packet insert so that said insert may be provided for use and/or distribution by said user.

36. The method of claim 35 further comprising the step of creating a user insert profile for said user, said user insert profile including at least on previously configured customized insert design specified by said user.

37. A method of providing a customized liquid packet insert to a user, the method comprising the steps of:
displaying a template insert;
allowing the user to modify the template insert with meaningful communications in accordance with the intentions of the user to achieve a desired appearance of the insert, and
deriving for the modified template insert a liquid packet insert that, when employed and/or distributed, advertises and/or informs and/or entertains according to the intents of the user,

38. The method of claim 37, wherein the step of modifying said template insert is performed by using a internet communication means.

39. The method of claim of 38, wherein the step of modifying said template insert is performed by incorporation of user-supplied text and/or graphic means.

40. The method of claim 39 further comprising the step of transmitting said liquid packet insert pattern to a manufacturing for the purpose of creating at least one liquid packet insert.

41. The method of claim 40 further comprising the step of ordering a liquid packet insert.

42. The method of claim 41 further comprising the step of assembling liquid packet insert and packaging material and liquid to fabricate and subsequent fabrication of at least one packet package with an enclosed liquid packet insert.

43. The method of claim 42 further comprising the step of employing and/or distributing said packet package so the liquid packet insert advertises and/or informs and/or entertains according to the intents of the said user.
